(19) United States
(12) Patent Application Publication
(10) Pub. No.: US 2010/0072144 A1
(43) Pub. Date: Mar. 25, 2010

(54) METHOD OF TREATING BALLAST WATER OF SHIP

(76) Inventors: Tsugiyoshi Osakabe, Aichi (JP); Masanori Inoko, Tokyo (JP); Yasushi Tsuchiya, Kanagawa (JP)

Correspondence Address: BIRCH STEWART KOLASCH & BIRCH, PO BOX 747, FALLS CHURCH, VA, 22040-0747, US

(21) Appl. No.: 12/443,140

(22) PCT Filed: Sep. 14, 2007
(86) PCT No.: PCT/JP2007/067968

§ 371 Date: Mar. 26, 2009

(30) Foreign Application Priority Data
Sep. 27, 2006 (JP) 2006-263450

(51) Int. Cl. C02F 1/50; C02F 1/70; C02F 1/76; B63B 13/00

(52) U.S. Cl. 210/752; 210/756

(57) ABSTRACT

A method of treating a ballast water for sterilizing bacteria, microorganisms or organisms in the ballast water in a hold or ballast tank of a ship, has the steps of: sterilizing the bacteria, microorganisms or organisms by adjusting a residual chlorine concentration in the ballast water to 1 mass ppm or more and 1000 mass ppm or less with a hypochlorite, and removing the residual chlorine in the ballast water with a sulfite.

### TECHNICAL FIELD

The present invention relates to reduction in the population of bacteria, a microorganisms or organisms present in ballast water in the hold or ballast tank of a ship.

### BACKGROUND ART

Ships carrying no or limited load is less balanced, as the waterline moves downward. Thus, such a ship assures it safety during voyage by storing ballast water therein. The ballast water is discharged out of the ship during loading of products at the destination and/or before entering into the harbor for loading.

The ballast water is sea water or fresh water withdrawn for example by pump into sealed compartments (e.g., tanks) installed in a ship for the purpose above before voyage. It may contain hazardous planktons, depending on the water area of withdrawal, and, if the ballast water is discharged into the coastal area or the port of the destination without any treatment, it may cause problems such as shellfish poisoning and red tide. Further, it is well known that the red tide once caused by bloom of toxic planktons results in oceanic pollution, severely damaging the fishes, shellfishes and others in the area, and particularly damaging the aquaculture industry. Known as countermeasures are methods of treating the ballast water by using hydrogen peroxide, calcium peroxide, or a hydroperoxide compound as a preventing and removing agent for red tide planktons of Rhizosolenia setigera, Prorocentrum micans, and so on (see e.g., JP-A-55-141142, “JP-A” means unexamined Japanese patent publication).

Also known are methods of sterilizing the cysts (dormant zygote) of toxic algae by adding a chlorine-based bactericide or hydrogen peroxide to ballast water of a ship (see e.g., JP-A-H04-322788). In the publication of JP-A-H04-322788, effective sterilizing action to Alexandrium cysts was confirmed, when a sodium hypochlorite is used as the chlorine-based bactericide, at a concentration of 10 ppm (residual chlorine content 1 ppm), 20 ppm (residual chlorine content 2 ppm), or 1000 ppm (residual chlorine content 100 ppm). Further, the publication describes that it was possible to detoxify the residual chlorine in the ballast water by the action of oxygen in air, when air was blown into the ballast water in wastewater by a pump of aeration apparatus.

Also known are methods of sterilizing the cysts of hazardous planktons in ballast water:
by using hydrogen peroxide (see e.g., JP-A-H05-910),
by heat treatment (see e.g., JP-A-H08-91288),
by using a fixed-bed electrolytic bath (see e.g., JP-A-2001-974),
by deoxygenation under vacuum (e.g., JP-A-2001-509729),
by reduction of oxygen concentration in gas phase to 2% or less by introduction of nitrogen gas into the ballast water (see e.g., JP-A-2002-234487),
by impact water pressure (see e.g., JP-A-2005-342626),
by ultrasonication (see e.g., JP-A-2006-7184), and by using chlorine dioxide (generated in the gas generator installed in ship) (see e.g., U.S. Pat. No. 6,773,611).

In addition, a sterilized water obtained by electrolysis of salt water was reported to have an oxidation-reduction potential of 820 mV or more, a dissolved chlorine concentration of 1 to 200 ppm, and a dissolved oxygen concentration of 50 ppm or less at room temperature at a pH of 4.0 or less (see e.g., JP-A-H08-89563).

Examples of known hazardous planktons include the followings:

### 1. Cyanophyceae

(1) Chroococcales
(2) Nostocales

### 2. Cryptophyceae

(1) Cryptomonadales

### 3. Dinophyceae

(1) Prorocentrales
(2) Dinophysiales
(3) Gymnodiniales
(4) Noctilucales
(5) Peridiniales

### 4. Bacillariophyceae

(1) Centrales
   (1-1) Coscinodiscineae
   (1-2) Rhizosoleniineae
   (1-3) Biddulphiineae
(2) Pennales
   (2-1) Araphidineae
   (2-2) Rhaphidineae

### 5. Raphidophyceae

(1) Raphidomonadales

### 6. Chrysophyceae

(1) Ochromonodales
(2) Pedinellales
(3) Dictyochales

### 7. Haptophyceae

(1) Isochrysidales
(2) Prymnesiales

### 8. Euglenophyceae

(1) Eutreptiales
(2) Euglenales

### 9. Prasinophyceae

(1) Nephroselmidales
(2) Pterospermatales
(3) Pyramimonadales

### 10. Chlorophyceae

(1) Volvocales

Hazardous planktons belonging to these species include those proliferating by asexual reproduction of asexual division and also those forming cysts by sexual reproduction between different mating types. The latter cysts, which correspond to seeds of flowering plats, germinate under certain environment, giving planktons. The external wall of the cysts has a very strong structure completely different from the cell wall membranes of planktons. The cysts are hence very persistent, as they remain alive in dormancy for several years even under the severe environments such darkness and reduction state prohibiting survival of planktons, and are thus completely different in physiology, ecology and shape from planktons that demand light and dissolved oxygen.

Phenomena of shellfish poisoning by shellfish toxin planktons were reported as early as around 1978 in the Volcano Bay in Hokkaido and along the Sanriku Coast. Recently, confirmed was presence of the cysts of shellfish-poisoning planktons in ballast water discharged from foreign ships. There are some reports on shellfish poisoning possibly due to the ballast water, suggesting a trend toward expansion in area and period of this phenomenon.

### DISCLOSURE OF INVENTION

The present invention addresses to sterilize bacteria, microorganisms or organisms in ballast water in the hold or the ballast tank of ship, and to remove the residual chlorine in the ballast water to be discharged.

After intensive studies to solve the problems above, the inventors have found that it was possible to solve the problems above by sterilizing bacteria, microorganisms or organisms (hereinafter, referred to as “organisms and others”) by adjusting the residual chlorine concentration in ballast water to 1 mass ppm or more and 1000 mass ppm or less with a hypochlorite and then removing the residual chlorine in the ballast water with a sulfite, and thus made the present invention.

According to the present invention, the following means are provided.

(1) A method of treating a ballast water for sterilizing bacteria, microorganisms or organisms in the ballast water in a hold or ballast tank of a ship, having the steps of: sterilizing the bacteria, microorganisms or organisms by adjusting a residual chlorine concentration in the ballast water to 1 mass ppm or more and 1000 mass ppm or less with a hypochlorite, and removing the residual chlorine in the ballast water with a sulfite.

(2) The method of treating a ballast water according to (1), wherein the bacteria, microorganisms or organisms in the ballast water are sterilized in a condition that an oxidation-reduction potential of the ballast water is adjusted to 600 mV or more by using the hypochlorite, and the residual chlorine in the ballast water is removed in a condition that the oxidation-reduction potential of the ballast water is adjusted to less than 500 mV with the sulfite.

(3) The method of treating a ballast water according to (2), wherein the ballast water is sea water, and wherein the bacteria, microorganisms or organisms in the ballast water are sterilized in a condition that the oxidation-reduction potential of the ballast water is adjusted to 700 mV or more by using the hypochlorite.

(4) The method of treating a ballast water according to (3), upon withdrawing the ballast water into the ship, wherein the oxidation-reduction potential of the ballast water is adjusted to 500 mV or more and less than 700 mV with the hypochlorite, and wherein the bacteria, microorganisms or organisms in the ballast water are sterilized in a condition that the oxidation-reduction potential of the ballast water is adjusted to 700 mV or more further by adding the hypochlorite.

(5) The method of treating a ballast water according to (3), upon withdrawing the ballast water into the ship, wherein the oxidation-reduction potential of the ballast water is adjusted to 500 mV or more and less than 700 mV with the hypochlorite, and wherein the bacteria, microorganisms or organisms in the ballast water are sterilized in a condition that the residual chlorine is adjusted to 2 mass ppm or more and 100 mass ppm or less further by adding the hypochlorite in accordance with an amount of the withdrawn ballast water.

(6) The method of treating a ballast water according to (2), upon withdrawing the ballast water into the ship, wherein the ballast water is fresh water, wherein the oxidation-reduction potential of the ballast water is adjusted to 450 mV or more and less than 600 mV with the hypochlorite, and wherein the bacteria, microorganisms or organisms in the ballast water are sterilized in a condition that the oxidation-reduction potential of the ballast water is adjusted to 600 mV or more further by adding the hypochlorite.

(7) The method of treating a ballast water according to (6), upon withdrawing the ballast water into the ship, wherein the oxidation-reduction potential of the ballast water is adjusted to 450 mV or more and less than 600 mV with the hypochlorite, and wherein the bacteria, microorganisms or organisms in the ballast water are sterilized in a condition that the residual chlorine is adjusted to 2 mass ppm or more and 100 mass ppm or less further by adding the hypochlorite in accordance with an amount of the withdrawn ballast water.

(8) The method of treating a ballast water according to (2), upon discharging the ballast water of which the bacteria, microorganisms or organisms therein are sterilized by using the hypochlorite, wherein the oxidation-reduction potential of the ballast water is adjusted to 500 mV or more and less than 600 mV with the sulfite, and wherein the ballast water is discharged with the oxidation-reduction potential thereof adjusted to less than 500 mV further by adding the sulfite.

(9) The method of treating a ballast water according to (2), upon discharging the ballast water of which the bacteria, microorganisms or organisms therein are sterilized by using the hypochlorite, wherein the oxidation-reduction potential of the ballast water is adjusted to 500 mV or more and less than 600 mV with the sulfite, and wherein the ballast water is discharged with the residual chlorine thereof adjusted to −30 mass ppm or more and 0 mass ppm or less further by adding the sulfite in accordance with an amount to be discharge.

(10) The method of treating a ballast water according to any one of (1) to (9), wherein the ballast water containing the hypochlorite has a pH in the range of from 5 to 9, and the ballast water of which the hypochlorite is removed with the sulfite has a pH in the range of from 5 to 9.

Other and further features and advantages of the invention will appear more fully from the following description, appropriately referring to the accompanying drawings.

### BRIEF DESCRIPTION OF DRAWINGS

FIG. 1 is a drawing of showing a preferred embodiment of a step of adding a hypochlorite to ballast water when fresh or sea water is withdrawn into a ship as the ballast water.

FIG. 2 is a drawing of showing a preferred embodiment of a step of adding a hypochlorite for initial consumption and then adding the hypochlorite additionally when fresh or sea water is withdrawn into a ship as the ballast water.

FIG. 3 is a drawing of showing a preferred embodiment of a step of eliminating the residual chlorine in ballast water with a sulfite when the ballast water is discharged from ship.

FIG. 4 is a drawing of showing a preferred embodiment of a step of eliminating the residual chlorine in ballast water without using an excessive sulfite when the ballast water is discharged from ship.

FIG. 5 is a graph of showing the relationship between the residual chlorine content and the oxidation-reduction potential in Example 3.

FIG. 6 is a graph of showing the relationship between the added chlorine amount and the residual chlorine content in Example 3.

FIG. 7 is a graph of showing the relationship between the added chlorine amount and the residual chlorine content in Example 4.

### DESCRIPTION OF PREFERRED EMBODIMENTS

Hereinafter, the present invention will be described in detail. In the description below, % means mass % and ppm means mass ppm.

In the present invention, the term “death” includes actually death of individuals of organisms and others, including the state where the individuals can not proliferate even though they are alive.

In the present invention, the ballast tank of ship means a water tank for controlling inclination of a ship. For example, the ballast tank may be a dedicated ballast tank for ship or may be an oil tank in tanker or a tank for storing ballast water installed in the hold.

In the present invention, ballast water includes both sea water and fresh water as well as brackish waster in combination of fresh water and sea water. In the present specification, the brackish water is considered and treated as sea water.

The method of the present invention include (1) a step of adjusting the residual chlorine concentration in ballast water withdrawn into a ship to 1 ppm or more and 1000 ppm or less by using a hypochlorite and leaving the mixture as it is for sterilization and/or damage organisms and others in the ballast water, and (2) a step of treating the residual chlorine in the ballast water discharged out of the ship into the safe state by neutralization treatment with a sulfite.

The chlorine-treated ballast water can be discharged out of the ship in the safe state by the method according to the present invention. In this way, the ballast water containing organisms and others in the water intake area, for example, does not give any adverse effect on the marine ecosystem of the water discharge area if discharged as it is, and also, the chlorine-treated ballast water discharged into the water, if discharged into the discharge area, does not give any damage on the aquatic organisms in the water discharge area.

Bacteria, microorganisms or organisms in ballast water are sterilized by the ballast water-treating method according to the present invention. The bacteria, microorganisms or organisms in ballast water are preferably bacteria and organisms having a size of 10 μm or more. The bacteria and organisms having a size of 10 μm or more in ballast water are those specified in the “International Convention for the Control and Management of Ships' Ballast Water and Sediments” established by the International Maritime Organization in February 2004. Typical examples of the bacteria and organisms having a size of 10 μm or more include bacteria such as pathogenic cholera, Escherichia coli and enterococci; microorganisms such as red tide planktons and water flea; and organisms such as ctenophora, asteroids, zebra mussel, brown seaweeds, crab, gobies and fresh eater crab (Eriocheir japonica). According to the provision in the Convention, cfu stands for colony forming unit (group unit), and the minimum size is the minimum dimension of height, width and depth.

In the present invention, the concentration of the pathogenic cholera contained in the ballast water discharged from ship is preferably less than 1 cfu/100 ml, the concentration of Escherichia coli is preferably less than 250 cfu/100 ml; the concentration of enterococcus is preferably less than 100 cfu/100 ml; the concentration of the organisms having a minimum size of 10 μm or more and less than 50 μm (mainly, phytoplanktons) is preferably less than 10 counts per ml; and the concentration of organisms having a minimum size of 50 μm or more (mainly, zooplanktons) is preferably less than 10 counts per m³.

The bacteria count can be determined by a flat plate method. The count of the organisms having a size of 10 μm or more can be determined by observing the size and number of the organisms in a formalin-fixed sample. Alternatively, the count of organisms of 10 to 50 μm in size can be determined by a vital staining method of using neutral red, while the count of organisms of 50 μm or more in size can be determined by using a sample previously concentrated with a nylon net having an opening of 20 μm.

### (1) Hypochlorite Treating Process

First, a step of sterilizing organisms and others in ballast water by treating the ballast water withdrawn into a ship with a hypochlorite will be described.

Mere control of the amount of a hypochlorite added may not be sufficient for sterilization of organisms and others in ballast water, and it can be determined based on the concentration of the hypochlorite still remaining after addition. In the present invention, the concentration of the hypochlorite in ballast water is expressed as residual chlorine. Namely, the residual chlorine concentration in the ballast water-treating method according to the present invention is 1 to 1000 ppm, preferably 2 to 100 ppm, and more preferably 2 to 30 ppm. When the residual chlorine concentration in ballast water is in the range above, the organisms and others in ballast water can preferably be sterilized.

Further, effective chlorine means an effective chlorine portion in the aqueous solution of the hypochlorite before addition to the ballast water, and may also be referred to as added chlorine or simply as chlorine portion.

The amount of the hypochlorite to be added to the ballast water varies according to the quality of the water withdrawn into ship as ballast water. Thus, the residual chlorine concentration differs significantly from the amount of the hypochlorite added to ballast water. For example, if the hypochlorite is added to a predetermined residual chlorine concentration, typical river water for drinking in Japan in summer consumes a hypochlorite amount of 2 ppm or less; but the coastal sea water in summer consumes that of 7 ppm to 12 ppm, and sea water rich with sea bottom water consumes that as high as 20 ppm, and thus, the residual chlorine concentration varies significantly. For that reason, a system of controlling the addition amount of the hypochlorite is important to establish a ballast water-treating method that can cope with water in any water quality. The control may be performed, for example, by manual analysis or by use of an effective chlorine concentration meter, but it is difficult to control the concentration effectively at high accuracy in a short period of time.

As for the method of controlling the residual chlorine concentration, it is possible to control the addition amount of the hypochlorite automatically at high accuracy by monitoring the oxidation-reduction potential (hereinafter, it may be referred to as ORP). This is a finding made by the inventors of the present invention.

In the ballast water-treating method according to the present invention, it is possible to sterilize organisms and others in the ballast water in the hold or the ballast water in the ballast tank of the ship, by adjusting the oxidation-reduction potential of the ballast water preferably to 600 mV or more, more preferably to 600 to 900 mV by using a hypochlorite. The oxidation-reduction potential is more preferably 650 to 900 mV and particularly preferably 700 to 800 mV. An oxidation-reduction potential of ballast water in the range above is preferable, as the organisms and others in ballast water are sterilized effectively. An oxidation-reduction potential of ballast water of less than 600 mV may not be effective enough in sterilizing the organisms and others in ballast water. Alternatively, an oxidation-reduction potential of ballast water of more than 900 mV is uneconomical, because consumption of the hypochlorite is larger.

The chlorine portion needed varies according to the quality of the withdrawn ballast water, and thus, the amount of the hypochlorite added to the ballast water in the present invention also varies. Thus if initial consumption cannot be estimated previously, it is necessary, for example, to inject the hypochlorite in excess (in a greater amount), which may lead to squandering of the hypochlorite.

On the other hand, the oxidation-reduction potential itself has some fluctuation in displayed numerical values such as temperature and pH by surrounding condition, because of its operational principle of the analytical instrument. It is thus possible to confirm that there is some residual chlorine by adjusting the oxidation-reduction potential of the ballast water during water withdrawal to 600 mV or more at a single addition of the hypochlorite, but it is still difficult to control the residual chlorine concentration to a desirable value at high precision.

It is thus preferable to adjust the residual chlorine concentration to a desired value by adding the hypochlorite to the ballast water multiple times. In this case, the oxidation-reduction potential may be measured after addition of the hypochlorite, but it is more preferable to add a certain amount of the hypochlorite additionally with reference to the amount of the ballast water during withdrawal, and in this way, it is possible to control the residual chlorine concentration easily. Therefore in the ballast water-treating method according to the present invention, it is preferable to adjust the oxidation-reduction potential of the ballast water preferably to 450 mV or more and less than 700 mV by using a hypochlorite during withdrawal of ballast water into ship and add the hypochlorite additionally according to the volume of the withdrawn water. The oxidation-reduction potential then is preferably 600 mV or more and higher than the adjusted oxidation-reduction potential above. It is possible to control the residual chlorine concentration properly and also to reduce the waste of chemicals by using the method. The method is also effective for example in reducing the amounts of by-products such as trihalomethanes.

The oxidation-reduction potential is adjusted by using multiple oxidation-reduction potentiometers or by using an oxidation-reduction potentiometer and a flow rate meter. In the present invention, it is preferable to use an oxidation-reduction potentiometer and a flow rate meter, because it is possible to obtain a desired residual chlorine amount by adding the hypochlorite according to the water volume after initial consumption of the hypochlorite.

The hypochlorite is preferably added to the ballast water once or multiple times, more preferably once or twice, and still more preferably twice.

If the ballast water is sea water (including brackish water), it is preferable to adjust the oxidation-reduction potential of the ballast water to 700 mV or more, more preferably 700 to 900 mV, and still more preferably 700 to 800 mV by using a hypochlorite. It is also preferable to adjust, upon withdrawing sea water into ship, the oxidation-reduction potential of the ballast water to 500 mV or more and less than 700 mV with the hypochlorite, and then adjust the oxidation-reduction potential of the ballast water to 700 mV or more (preferably 700 to 800 mV) by addition of the hypochlorite additionally. It is also preferable to adjust, upon withdrawing sea water into ship, the oxidation-reduction potential of the ballast water to 500 mV or more and less than 700 mV with the hypochlorite, and then adjust the residual chlorine concentration in ballast water further to 2 to 100 ppm, still more preferably to 2 to 30 ppm, by adding the hypochlorite according to the withdrawn water quantity.

If the ballast water is fresh water, it is preferable to adjust the oxidation-reduction potential of the ballast water to 600 mV or more, more preferably 650 to 900 mV, and still more preferably 650 to 800 mV by using a hypochlorite. It is also preferable to adjust, upon withdrawing sea water into ship, the oxidation-reduction potential of the ballast water 450 mV or more and less than 600 mV with hypochlorite, and then adjust the oxidation-reduction potential of the ballast water to 600 mV or more (preferably 650 to 800 mV) further by addition of the hypochlorite. It is also preferable to adjust, upon withdrawing sea water into ship, the oxidation-reduction potential of ballast water to 450 mV or more and less than 600 mV with hypochlorite, and then adjust the residual chlorine concentration in ballast water to 2 to 100 ppm, more preferably 2 to 30 ppm, further by adding the hypochlorite according to the withdrawn water quantity.

In the present invention, the period of residual chlorine treatment is not particularly limited, if it allows damaging or sterilization of the organisms and others in ballast water (e.g., bacteria and cysts), but preferably 10 minutes or more. The longest treatment period may be determined according to the voyage period of the ship. Specifically, it is a period calculated by subtracting the period of sulfite treating period from the period from the day of withdrawing ballast water to the day of discharging it after arrival to the destination. The treatment period is as above, the organisms and others in ballast water (bacteria and cysts, etc.) can effectively be sterilized, and it is preferable that the ballast water may be discharge without any problems.

When the hypochlorite is added to the ballast water multiple times in the present invention, the interval of repeated addition is not particularly limited, if it allows preservation of the residual chlorine at a predetermined concentration. The tanks used for repeated addition may be connected to each other simply with a pipe, or a mixer or an additional tank may be installed between them. For example, the interval may be 1 second or more and 1 hour or less.

The hypochlorite in the present invention can be used in the form of an aqueous solution of an alkali-metal salt such as of sodium or potassium or an alkali-earth metal salt such as of calcium. Because potassium and others are nutrient components for plants and barium and others are toxic, use of the naturally abundant sodium salt is most preferable, as handling is easier.

In the present invention, the treatment temperature with sodium hypochlorite is normally 0 to 40° C., preferably 5 to 35° C., more preferably 5 to 25° C., and still more preferably 5 to 20° C. Preferably at the temperature above, the organisms and others in ballast water (microbe and cyst, etc.) can be effectively sterilized.

### (2) Sulfite Treating Process

Hereinafter, the step of treating the residual chlorine in the ballast water discharged out of the ship into the safe state by neutralization with a sulfite will be described.

The residual chlorine has adverse effects on aquatic organisms if present even in an extremely trace amount, and thus, it is needed to reduce its concentration to 0.01 ppm or less during discharge. Although it is possible to detoxify chlorine by aeration, the operation demands a certain period, and, for example if the ballast water is treated in a port, it leads to increase in demurrage. For that reason, there is a need for a method of eliminating the residual chlorine in a short period of time. In the ballast water-treating method according to the present invention, the residual chlorine is removed by using a sulfite with regard to discharging the ballast water.

In discharging the ballast water out of the ship, it is preferable not to discharge the ballast water in the low oxygen state. Specifically, it is preferable not to make the ballast water discharged in the low oxygen state disturb aquatic organisms around the ship. Normal sea water has a dissolved oxygen concentration of 7 to 8.5 mg/L, while the dissolved oxygen concentration indicating oxygen deficiency of the sea water during aquaculture is 6 mg/L or more. The sulfite, if present in excess, is converted to the naturally present sulfate, as oxidized by oxygen in air and also by consumption of the dissolved oxygen. In this case, the ballast water in ballast tank may be aerated, or air may be blown into the discharge pipe, but such operation also leads to increase in demurrage, similarly as described above. It is thus important to adjust the amount of the sulfite added amount to a suitable amount. In the method too, it is effective to use the oxidation-reduction potential efficiently, similarly to the case of the hypochlorite.

In the ballast water-treating method according to the present invention, it is possible to eliminate the residual chlorine by adjusting the oxidation-reduction potential of the discharge water to less than 500 mV with a sulfite, when the ballast water containing residual chlorine is discharged. The oxidation-reduction potential of the discharge water is more preferably 200 or more and less than 500 mV, and still more preferably 350 or more and less than 450 mV.

In addition, because there are areas where the dissolved oxygen is limited, most preferable for stricter control is a method to adjust the oxidation-reduction potential of the ballast water to be discharged once into the range of 500 mV or more and less than 600 mV by addition of a sulfite, and then to adjust the oxidation-reduction potential to less than 500 mV by addition of a predetermined amount of the sulfite in proportion to the handling water quantity. The oxidation-reduction potential is adjusted by using multiple oxidation-reduction potentiometers or by using an oxidation-reduction potentiometer and a flow rate meter. In the present invention, it is preferable to use an oxidation-reduction potentiometer and a flow rate meter, because it is possible to obtain a desired residual chlorine content after initial consumption of the sulfite by addition of the sulfite according to the water volume.

If the ballast water is sea water (including brackish water) or if the ballast water is fresh water, when ballast water in which the organisms and others are sterilized by using a hypochlorite is discharged, it is particularly preferable to discharge the ballast water in which the oxidation-reduction potential of the ballast water is adjusted to 500 mV or more and less than 600 mV by using a sulfite, and additionally, the oxidation-reduction potential is adjusted to less than 500 mV, more preferably 200 mV or more and less than 500 mV, and particularly preferably 350 to 450 mV further by adding the sulfite.

If the ballast water is sea water (including brackish water) or if the ballast water is fresh water, when ballast water in which organisms and others are sterilized by using a hypochlorite is discharged, it is preferable to discharge the ballast water in which the oxidation-reduction potential of the ballast water is adjusted to 500 mV or more and less than 600 mV by using a sulfite, and additionally, the residual chlorine is adjusted to −30 to 0 ppm, more preferably −20 to −0.1 ppm, particularly preferably −10 to −0.1 ppm, further by addition of a sulfite in proportion to the discharge quantity. It is because a residual chlorine of less than −30 ppm (with much residual sulfite) leads to rapid decrease in dissolved oxygen concentration. The residual chlorine is not present when the sulfite is present in excess, and thus, a negative residual chlorine indicates a calculated chlorine amount needed for eliminating the excess sulfite (corresponding to the molar number of the sulfite). For example, if the sulfite is sodium sulfite, when the excess amount of sodium sulfite is 126 ppm, the residual chlorine is calculated as −70.9 ppm.

The sulfite in the present invention can be used in the form of aqueous solution of an alkali-metal salt such as of sodium or potassium, but preferably a sodium salt.

In the present invention, the treatment temperature with sodium sulfite is normally 0 to 40° C., preferably 5 to 35° C., more preferably 5 to 25° C., and still more preferably 5 to 20° C. Favorably at the temperature, it is possible to eliminate the residual chlorine in ballast water efficiently.

In the present invention, each of the pH of the hypochlorite containing ballast water and the pH of the ballast water of which the hypochlorite is removed with the sulfite is preferably 5 to 9, more preferably pH 5.8 to 8.6, more preferably pH 6.0 to 8.5, and particularly preferably 6.5 to 8.0. Preferably if the pH of the hypochlorite containing ballast water and the pH of the hypochlorite removed ballast water are in the range above, the organisms and others in ballast water (microbe and cyst, etc.) are sterilized effectively.

Decrease in pH is known to suppress generation of trihalomethanes, which derive from the reaction with residual chlorine. It is thus possible to suppress generation of trihalomethanes by adjusting the pH of the ballast water with an acid such as sulfuric acid, hydrochloric acid or acetic acid even when the residual chlorine concentration is higher.

In the ballast water-treating method according to the present invention, the aqueous hypochlorite solution may be added when the sea or fresh water is withdrawn as ballast water into ship or after the sea or fresh water is supplied into the ballast tank. In the ballast water-treating method according to the present invention, the hypochlorite is more preferably added when the sea or fresh water is withdrawn as ballast water.

The residual chlorine-containing ballast water is ballast water that is discharged after neutralization with a sulfite, and the sulfite may be added to the ballast tank or to the ballast water during discharge. In the ballast water-treating method according to the present invention, the sulfite is more preferably added to the ballast water during discharge.

A ship carrying a hypochlorite may dispose of the hypochlorite as it is into sea, lake or river in an emergency situation such as collision, fire or water immersion. In such a case, the hypochlorite pollutes the sea, lake or river. It is possible to prevent water pollution by neutralizing the sulfite as a counter measure before disposal of the hypochlorite. The sulfite may be supplied as solid or in the state of aqueous solution, and storage thereof as in an aqueous solution is preferable for convenience in handling.

Examples of the method of disposing of the hypochlorite include a method of decomposing the hypochlorite after decomposing the residual chlorine by adding an aqueous sulfite solution to the hypochlorite in storage tank, a method of disposing of the hypochlorite for example into sea after decomposing the residual chlorine by mixing an aqueous sulfite solution with the ballast water in discharge pipe, a method of disposing of the hypochlorite for example into sea after decomposing the residual chlorine by adding an aqueous sulfite solution to the ballast water in ballast tank and additionally mixing the aqueous sulfite solution with the ballast water in a discharge pipe, a method of disposing of the hypochlorite after decomposing the residual chlorine by adding an aqueous sulfite solution into the ballast tank, and the like.

It is possible by using one of the methods above to reduce the risk of generation of chlorine gas from the hypochlorite by heating of the hypochlorite storage tank and/or the ballast tank containing hypochlorite during fire.

Hereinafter, a preferred embodiment of the method of treating the ballast water according to the present invention will be described in detail with reference to attached drawings. In description of each Figure, the same reference numerals are allocated to the same elements.

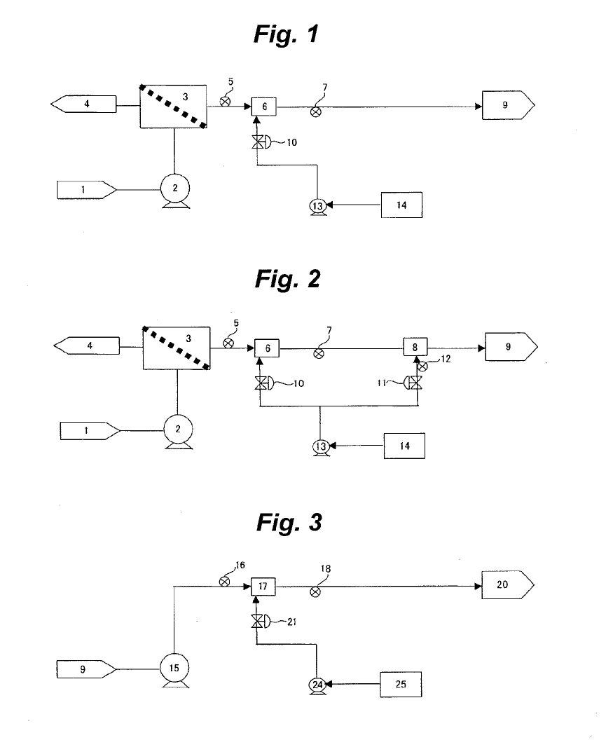

First, methods of controlling hypochlorite injection will be described briefly with reference to FIG. 1 or 2.

### (Single Addition of Hypochlorite)

FIG. 1 is a schematic diagram showing a preferred embodiment of the step of adding a hypochlorite to ballast water when the ballast water is withdrawn into ship. First, fresh or sea water is withdrawn through an intake port 1 by a water intake pump 2 and fed as filtered through a filter 3 having an opening size of 50 μm into a mixer 6. The solids having a diameter of 50 μm or more trapped by the filter 3 are returned to the water intake region 4. A hypochlorite in a chemical tank 14 is fed to the mixer 6 by a chemical-feeding pump 13, while the chemical-adjusting valve 10 is so adjusted that the value, as determined by an oxidation-reduction potentiometer 7, becomes 600 mV or more by using a flowmeter 5 and an oxidation-reduction potentiometer 7, and the resulting ballast water is fed to the ballast water tank 9.

### (Double Addition of Hypochlorite)

FIG. 2 is a schematic diagram showing another preferred embodiment of the step of adding a hypochlorite to ballast water when the ballast water is withdrawn into ship. First, fresh or sea water is withdrawn through an intake port 1 by a water intake pump 2 and fed through a filter 3 having an opening of a size of 50 μm once into a first-stage mixer 6 (wherein, solids of 50 μm or more in size are returned into the water intake region 4). A hypochlorite in chemical tank 14 is introduced into the first-stage mixer 6 by a chemical-feeding pump 13, while the opening of the ORP output-controlled chemical-adjusting valve 10 is adjusted based on the signal from an oxidation-reduction potentiometer 7, so that the oxidation-reduction potential becomes 450 or more and less than 700 mV (pre-ballast water). The effective chlorine in hypochlorite reacts rapidly with the reactive components almost completely, leaving no residual chlorine, in the early stage of this step. Accordingly, additional hypochlorite is added to the pre-ballast water in the second-stage mixer 8, while the flow rate of the hypochlorite is adjusted (based on the concentration of the hypochlorite in chemical tank 14) by the opening of a flowmeter output-controlled chemical-adjusting valve 11 based on the information on flow rate from a flow meter 5 (accuracy improved by conversion of the information from flow meter 5 to signal for chemical flowmeter 12 and adjustment of the opening of valve 11 by the chemical flowmeter 12). In this way, the ballast water containing a particular excess amount of residual chlorine is fed into a tank 9. In FIG. 2, the mixers 6 and 8 are connected to each other with a pipe, but a mixer or a tank may be installed there additionally for improvement in mixing efficiency.

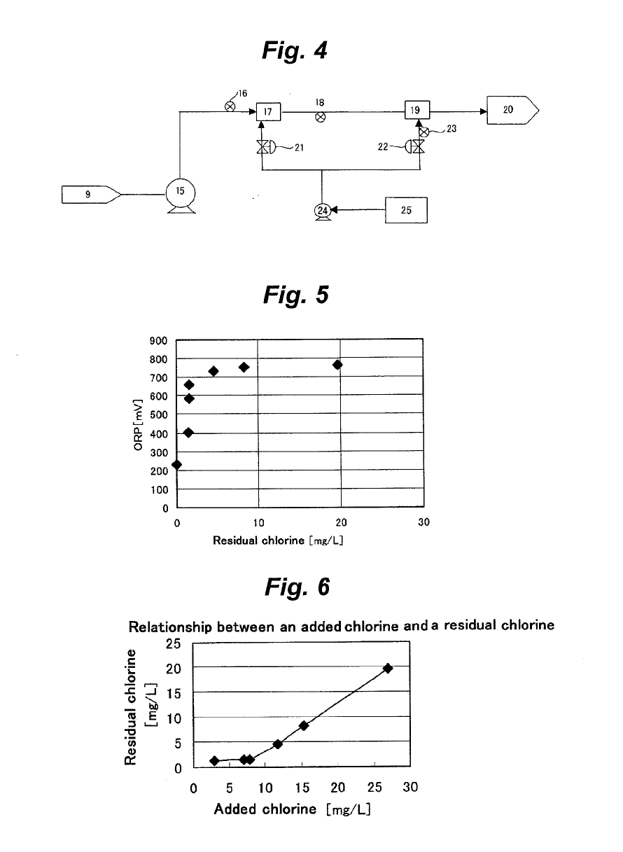

Hereinafter, the method of controlling sulfite injection in the ballast water-treating method according to the present invention will be described briefly with reference to FIGS. 3 and 4.

### (Single Addition of Sulfite)

FIG. 3 is a schematic diagram showing a preferred embodiment of the step of adding a sulfite to the ballast water during discharge of the ballast water from ship. First, ballast water is withdrawn from a ballast water tank 9 by a discharge pump 15 and fed into a mixer 17. Then, the sulfite in a chemical tank 25 is supplied by a chemical-feeding pump 24 into the mixer 17, while the chemical-adjusting valve 21 is adjusted under control of a flowmeter 16 and an oxidation-reduction potentiometer 18, to make the value, as determined by the oxidation-reduction potentiometer 18, less than 500 mV for removal of the residual chlorine in discharge water, and the resulting water is discharged into a discharge region 20.

### (Double Addition of Sulfite)

FIG. 4 is a schematic diagram showing another preferred embodiment of the method of adding a sulfite to the ballast water discharged from ship. The ballast water is first fed from a ballast water tank 9 to a first-stage mixer 17 by a discharge pump 15. A sulfite in a chemical tank 25 is introduced into a mixer 17 by a chemical-feeding pump 24 while the opening of an ORP output-control chemical-adjusting valve 21 is adjusted based on the signal from an oxidation-reduction potentiometer 18 so that a value of 500 mV or more and less than 600 mV is obtained (pre-discharge). In this stage, almost all residual chlorine reacts with the sulfite, leaving almost no residual chlorine. However, the residual chlorine should be reduced to 0.01 ppm or less before discharge, and thus, it is necessary to remove it reliably. Thus, additional sulfite is added to the pre-discharge water in the second-stage mixer 19, while the flow rate of the sulfite (considering the concentration of the sulfite in chemical tank 25) is adjusted (conversion of the information from the flowmeter 16 into the signal of chemical flowmeter 23 and subsequent adjustment of the opening of the flowmeter output-control chemical-adjusting valve 22 by the chemical flowmeter 23 allow improvement in accuracy), based on the information from a flowmeter 16. In this way, treated ballast water with no residual chlorine and with the sulfite in an amount not more than needed is discharged into the discharge region 20. In FIG. 4, the mixers 17 and 19 are connected with each other with a pipe, but, for example, a mixer or a tank may be installed there additionally for improvement in mixing efficiency.

According to the method of treating the ballast water of the present invention organisms and others in ballast water can be sterilized, and the ballast water containing no toxic component can be discharged. Further, according to the method of treating the ballast water of the present invention, residual chlorine-free treated water can be discharged, not damaging aquatic organisms in the water discharge area.

The present invention will be described in more detail based on examples given below, but the invention is not meant to be limited by these.

### EXAMPLE

### Example 1

### Step 1: Hypochlorite Treating Process

An aqueous sodium hypochlorite solution (trade name: Aronclean LB, manufactured by Toagosei Co., Ltd.) was added to 2.6 L of fresh water in every approximately 5 minutes, the temperature, pH, residual chlorine content (mg/L), oxidation-reduction potential (ORP) and dissolved oxygen (DO) then were determined, and the results are summarized in Table 1. The residual chlorine content was determined by a titration method of using potassium iodide and sodium thiosulfate, and the other items were determined respectively by using proper instruments. The specific density of the fresh water used was 1.00, and the unit mg/L in Table is equivalent to ppm.

TABLE 1

| Residual chlorine content | | Temperature | DO | ORP |
|---|---|---|---|---|
| mg/L | pH | ° C. | mg/L | mV |
| Initial value | 6.94 | 28.5 | — | 289 |
| 0 | 6.94 | 28.5 | — | 289 |
| 0 | 6.97 | 28.5 | — | 288 |
| 0.9 | 7.1 | 28.5 | — | 591 |
| 2.7 | 7.33 | 28.3 | 7.9 | 656 |
| 5.6 | 7.55 | 28.3 | 7.8 | 674 |
| 9.0 | 7.72 | 28.3 | 7.7 | 684 |
| 11.5 | 7.82 | 28.1 | 7.7 | 697 |
| 15.2 | 7.92 | 28.1 | 7.7 | 707 |
| 23.0 | 8.06 | 28 | — | 711 |

From the results, increase of the residual chlorine content to more than 1 mg/L was found to be accompanied with increase in ORP value.

In addition, the results on toxicity to fishes showed that a residual chlorine content of 5 mg/L or more leads to damage and finally death of the fishes in a short period of time of approximately 5 minutes. The results indicated that it was possible to sterilize organisms and others in ballast water by keeping the ORP of the ballast water at 600 mV or more.

### Step 2: Sulfite Treating Process

Subsequently, an aqueous sodium sulfite solution was added to water having a residual chlorine content of 23 mg/L and an oxidation-reduction potential of 729 mV, until there was no residual chlorine. Sodium sulfite was added additionally, and the ORP and others were determined then. The results are summarized in Table 2. Although there was no residual chlorine when sodium sulfite was added in excess, the residual chlorine content was shown as a negative value in Table 2, showing that the sodium sulfite is present in excess. Specifically, 126 mg/L of sodium sulfite is equivalent to −70.9 mg/L after conversion. The specific density of the water used was 1.00, and the unit mg/L in Table is equivalent to ppm.

TABLE 2

| Residual chlorine content | | Temperature | | ORP |
|---|---|---|---|---|
| mg/L | pH | ° C. | DO | mV |
| 23.0 | 8.05 | 27.9 | 7.7 | 729 |
| 5.5 | 7.67 | 27.9 | 7.6 | 707 |
| 0.0 | 7.56 | 27.9 | 7.6 | 430 |
| −1.7 | 7.55 | 27.9 | 7.6 | 367 |
| −4.1 | 7.52 | 27.8 | 7.4 | 276 |
| −13.2 | 7.74 | 27.8 | 7.5 | 226 |

As a result, it was considered that there was no influence by sodium hypochlorite even in a trace amount when the residual chlorine content was not measurable and the ORP was less than 500 mV.

Separately, damage on fishes was examined when the residual chlorine amount is less than 0 mg/L, showing that there was no significant damage in a short period of time. In addition, damage on fishes by water (adjusted to pH 8) having an ORP of −63 mV after addition of sodium sulfite was studied, showing that there was significantly damage, finally causing death of fishes. The results show that discharge of water containing a large excess amount of the sulfite out of the ship lead to adverse effects on aquatic organisms.

### Example 2

### Step 1: Hypochlorite Treating Process

A treatment was carried out in a similar manner to Example 1, except that 2.6 L of fresh water in Step 1 was replaced with 2.5 L of sea water. Specifically, an aqueous sodium hypochlorite solution (trade name: Aronclean LB, manufactured by Toagosei Co., Ltd.) was added to 2.5 L of sea water in portions at an interval of approximately 5 minutes, and the temperature, pH, residual chlorine content (mg/L) and oxidation-reduction potential (ORP) were determined. The results are summarized in Table 3. The specific density of the sea water used was 1.03, and the numerical value obtained by dividing the unit mg/L in Table by 1.03 is equivalent to a value expressed in ppm.

TABLE 3

| Residual chlorine content | | Temperature | ORP |
|---|---|---|---|
| mg/L | pH | ° C. | mV |
| Initial value | 8.1 | 25.8 | 183 |
| 0 | 8.1 | 25.8 | 212 |
| 0 | 8.1 | 25.8 | 268 |
| 0 | 8.1 | 25.8 | 343 |
| 1.1 | 8.1 | 25.8 | 629 |
| 1.9 | 8.1 | 25.8 | 720 |
| 2.9 | 8.2 | 25.7 | 736 |
| 6.0 | 8.3 | 25.8 | 753 |
| 11.5 | 8.4 | 25.8 | 758 |
| 16.9 | 8.5 | 25.8 | 748 |
| 20.3 | 8.5 | 25.8 | 724 |

The results in Table 3 showed that, similarly to the treatment in Step 1 of Example 1, a residual chlorine content of 1 mg/L or more lead to increase of the ORP value.

### Step 2: Sulfite Treating Process

Subsequently, an aqueous sodium sulfite solution was added to water having a residual chlorine content of 20 mg/L and an oxidation-reduction potential of 724 mV, until there was no residual chlorine content. Sodium sulfite was added additionally, and the ORP and others were determined then. Consequently, there were obtained results similar to those obtained by the treatment in Step 2 of Example 1.

### Example 3

A treatment was carried out in a similar manner to Example 2, except that 2.5 L of sea water in Step 1 of Example 2 was replaced with 1.5 L of sea water. Specifically, similarly to the treatment in Step 1 of Example 2, an aqueous sodium hypochlorite was added to the other sea water (1.5 liter) and the temperature, residual chlorine content (mg/L) and oxidation-reduction potential were determined. The results are summarized in Table 4. In Table 4, the chlorine amount (mg/L) added is an integrated amount of the effective chlorine in the aqueous sodium hypochlorite solution added to the sea water. The specific density of the sea water used was 1.03, and the numerical value obtained by dividing the unit mg/L in Table by 1.03 is equivalent to a value expressed in ppm.

TABLE 4

| Residual chlorine | Residual chlorine | | |
|---|---|---|---|
| content | content | Temperature | ORP |
| mg/L | mg/L | ° C. | mV |
| Initial value | — | 25.0 | 232 |
| 2.9 | 1.4 | 25.0 | 403 |
| 7.1 | 1.6 | 25.0 | 584 |
| 7.8 | 1.6 | 25.1 | 660 |
| 11.7 | 4.6 | 25.1 | 732 |
| 15.3 | 8.3 | 25.1 | 753 |
| 26.9 | 19.6 | 25.1 | 765 |

FIG. 5 shows the relationship between the residual chlorine content and the oxidation-reduction potential, while FIG. 6 shows the relationship between the added chlorine amount and the residual chlorine content.

As obvious from the results in Table 4 and FIGS. 5 and 6, increase in added chlorine amount leads to increase in ORP value, but there was some region in the initial phase of the hypochlorite addition where the residual chlorine did not increase in proportion. As shown in FIG. 5, there was significant change in ORP value in the initial phase of chlorine addition, but there was smaller change in ORP value since then, indicating that it was difficult to control the residual chloride from the ORP value precisely. In the present Example, the state having an ORP value of up to about 600 mV (added chlorine: about 7.5 mg/L) corresponds to the state in the initial phase when the chlorine is consumed. Thus, the aqueous hypochlorite solution is added once to an ORP close to the value, specifically to 450 to 700 mV, and the solution added corresponds to the chlorine initially consumed. Thereafter, it is possible to retain the residual chlorine concentration needed for ballast water treatment by adding the hypochlorite in an amount in proportion to the amount of the withdrawn water or to a particular ORP value, as determined by an ORP meter.

### Example 4

### Step 1: Hypochlorite Treating Process

An aqueous sodium hypochlorite solution (trade name: Aronclean LB, manufactured by Toagosei Co., Ltd.) was added to sea water (oxidation-reduction potential; 232 mV) to a desired oxidation-reduction potential of 650 mV, while the oxidation-reduction potential was monitored. The effective chlorine added to the sea water during addition was 7.8 mg/L, and the measured residual chlorine was 1.6 mg/L. The oxidation-reduction potential determined at the same time was 660 mV.

In addition, the same sodium hypochlorite was added to the sea water in an amount corresponding to the 7.5 mg/L of effective chlorine. The residual chlorine, as determined after second addition, was 8.3 mg/L. The oxidation-reduction potential simultaneously determined was 753 mV.

For confirmation, the same sodium hypochlorite was added additionally to the sea water in an amount corresponding to 11.6 mg/L of effective chlorine. The residual chlorine, as determined after third addition, was 19.6 mg/L. The oxidation-reduction potential simultaneously determined was 765 mV.

For confirmation, the same sodium hypochlorite was added additionally to the sea water in an amount corresponding to 3.5 mg/L of effective chlorine. The residual chlorine, as determined after fourth addition, was 23.1 mg/L. The oxidation-reduction potential simultaneously determined was 770 mV.

The solution was left in the state for sterilization for some time. The residual chlorine determined after then was 20.3 mg/L. The oxidation-reduction potential simultaneously determined was 769 mV.

### Step 2: Sulfite Treating Process

Subsequently, a sodium sulfite solution was added to a desired oxidation-reduction potential of 600 mV. Similarly to the treatment in Step 2 of Example 1, the amount of sodium sulfite added to the sea water during addition corresponds to a residual chlorine of −23 mg/L, and the residual chlorine actually determined was 1.0 mg/L and the oxidation-reduction potential was 590 mV. In addition, the same sodium sulfite was added to the sea water in an amount corresponding to −1.5 mg/L of residual chlorine with respect to the volume of the sea water. The residual chlorine, as determined after second addition, was −0.4 mg/L, and the oxidation-reduction potential then was 355 mV.

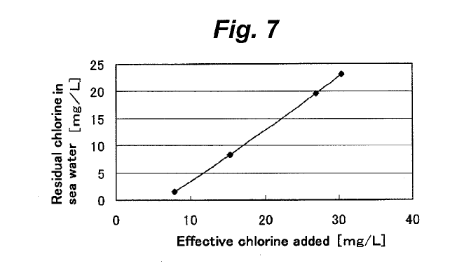

Test results of the residual chlorine contents and the oxidation-reduction potentials (ORP) in the steps above are summarized in Table 5. The specific density of the sea water used was 1.03, and the numerical value obtained by dividing the unit mg/L in Table by 1.03 is equivalent to a value expressed in ppm. FIG. 7 shows the relationship between the added chlorine amount and the residual chlorine content.

TABLE 5

| | Effective | Sodium | | | |
|---|---|---|---|---|---|
| | chlorine | sulfite added | Residual | | |
| | added | (as chlorine) | chlorine | | |
| | mg/L | mg/L | content | ORP | Temperature |
| Process | (cumulative) | (cumulative) | mg/L | mV | ° C. |
| Step 1 | 0.0 | — | — | 232 | 25.0 |
| | 7.8 | — | 1.6 | 660 | 25.1 |
| | 15.3 | — | 8.3 | 753 | 25.1 |
| | 26.9 | — | 19.6 | 765 | 25.1 |
| | 30.4 | — | 23.1 | 770 | 25.2 |
| Left as it | 30.4 | — | 20.3 | 769 | 25.8 |
| is | | | | | |
| Step 2 | — | −23.0 | 1.0 | 590 | 25.8 |
| | — | −24.5 | −0.4 | 355 | 25.8 |

In the present Example, a sodium hypochlorite solution was added in four orders (four times) to study the relationship between the effective chlorine added and the residual chlorine. As obvious from the results, the effective chlorine initially added was not detected as residual chlorine as it is consumed, but the effective chlorine added in the second portion and later with reference to oxidation-reduction potential was detected as residual chlorine. Although the solution was divided into four times addition in the present Example, the same is true if it is divided into two times.

In this way, it is possible to consume the chemical properly by identifying the residual chlorine in the ballast after consumption in the early phase by a simple method and adding the chlorine gradually in portions by calculating the required residual chlorine content from the volume of the ballast water and also for example from voyage distance. If the residual chlorine is controlled only with the oxidation-reduction potential, the change in the value of oxidation-reduction potential is smaller, and thus, it is difficult to control the residual chlorine precisely, but possible to control it easily by adding it in proportion to the ballast water.

Similarly, although the residual chlorine concentration is also arbitrary before removal of the residual chlorine before discharge, it is possible to add the sulfite arbitrarily and adjust the ballast water discharged by identifying the initial decrease by a simple method of calculating the amount of the sulfite suitable for discharge without leaving residual chlorine and yet without concern about oxygen deficiency for example from the volume of the ballast water. Because the sulfite reacts with dissolved oxygen and others, it is difficult to treat the ballast water properly even if it is added after accurate measurement of the residual chlorine concentration.

As obvious from the results in Examples above, it was possible to sterilize the organisms and others in ballast water in the hypochlorite treating process (Step 1) and to remove the residual chlorine in ballast water in the following sulfite treating process (Step 2).

Thus, according to the method of the present invention, there possibly shows no adverse effects on the marine ecosystem of the water discharge area such that the ballast water containing organisms and others in the water intake area is discharged as it is, and there possibly shows no damage on the aquatic organisms in the water discharge area such that the chlorine-treated ballast water is released into the water discharge area.

### INDUSTRIAL APPLICABILITY

It is possible by using the method of sterilizing ballast water according to the present invention to sterilize cysts and others in ballast water and discharge toxic component-free ballast water at low cost. Accordingly, the method possibly prohibits penetration of foreign organisms and others via ballast water and prevents adverse effects on the aquatic organisms in the area where the ballast water is discharged.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119(a) on Patent Application No. 2006-263450 filed on Sep. 27, 2006, which is herein incorporated by reference.

1. A method of treating a ballast water for sterilizing bacteria, microorganisms or organisms in the ballast water in a hold or ballast tank of a ship, comprising the steps of: sterilizing the bacteria, microorganisms or organisms by adjusting a residual chlorine concentration in the ballast water to 1 mass ppm or more and 1000 mass ppm or less with a hypochlorite, and removing the residual chlorine in the ballast water with a sulfite.

2. The method of treating a ballast water according to claim 1, wherein the bacteria, microorganisms or organisms in the ballast water are sterilized in a condition that an oxidation-reduction potential of the ballast water is adjusted to 600 mV or more by using the hypochlorite, and the residual chlorine in the ballast water is removed in a condition that the oxidation-reduction potential of the ballast water is adjusted to less than 500 mV with the sulfite.

3. The method of treating a ballast water according to claim 2, wherein the ballast water is sea water, and wherein the bacteria, microorganisms or organisms in the ballast water are sterilized in a condition that the oxidation-reduction potential of the ballast water is adjusted to 700 mV or more by using the hypochlorite.

4. The method of treating a ballast water according to claim 3, upon withdrawing the ballast water into the ship, wherein the oxidation-reduction potential of the ballast water is adjusted to 500 mV or more and less than 700 mV with the hypochlorite, and wherein the bacteria, microorganisms or organisms in the ballast water are sterilized in a condition that the oxidation-reduction potential of the ballast water is adjusted to 700 mV or more further by adding the hypochlorite.

5. The method of treating a ballast water according to claim 3, upon withdrawing the ballast water into the ship, wherein the oxidation-reduction potential of the ballast water is adjusted to 500 mV or more and less than 700 mV with the hypochlorite, and wherein the bacteria, microorganisms or organisms in the ballast water are sterilized in a condition that the residual chlorine is adjusted to 2 mass ppm or more and 100 mass ppm or less further by adding the hypochlorite in accordance with an amount of the withdrawn ballast water.

6. The method of treating a ballast water according to claim 2, upon withdrawing the ballast water into the ship, wherein the ballast water is fresh water, wherein the oxidation-reduction potential of the ballast water is adjusted to 450 mV or more and less than 600 mV with the hypochlorite, and wherein the bacteria, microorganisms or organisms in the ballast water are sterilized in a condition that the oxidation-reduction potential of the ballast water is adjusted to 600 mV or more further by adding the hypochlorite.

7. The method of treating a ballast water according to claim 6, upon withdrawing the ballast water into the ship, wherein the oxidation-reduction potential of the ballast water is adjusted to 450 mV or more and less than 600 mV with the hypochlorite, and wherein the bacteria, microorganisms or organisms in the ballast water are sterilized in a condition that the residual chlorine is adjusted to 2 mass ppm or more and 100 mass ppm or less further by adding the hypochlorite in accordance with an amount of the withdrawn ballast water.

8. The method of treating a ballast water according to claim 2, upon discharging the ballast water of which the bacteria, microorganisms or organisms therein are sterilized by using the hypochlorite, wherein the oxidation-reduction potential of the ballast water is adjusted to 500 mV or more and less than 600 mV with the sulfite, and wherein the ballast water is discharged with the oxidation-reduction potential thereof adjusted to less than 500 mV further by adding the sulfite.

9. The method of treating a ballast water according to claim 2, upon discharging the ballast water of which the bacteria, microorganisms or organisms therein are sterilized by using the hypochlorite, wherein the oxidation-reduction potential of the ballast water is adjusted to 500 mV or more and less than 600 mV with the sulfite, and wherein the ballast water is discharged with the residual chlorine thereof adjusted to −30 mass ppm or more and 0 mass ppm or less further by adding the sulfite in accordance with an amount to be discharge.

10. The method of treating a ballast water according to claim 1, wherein the ballast water containing the hypochlorite has a pH in the range of from 5 to 9, and the ballast water of which the hypochlorite is removed with the sulfite has a pH in the range of from 5 to 9.
